(19) United States
(12) Patent Application Publication
(10) Pub. No.: US 2010/0106758 A1
(43) Pub. Date: Apr. 29, 2010

(54) COMPUTING DISCRETE FOURIER TRANSFORMS

(75) Inventors: Naga K. Govindaraju, Redmond, WA (US); David Brandon Lloyd, Redmond, WA (US); Yuri Dotsenko, Redmond, WA (US); Burton Jordan Smith, Seattle, WA (US); Jon L. Manferdelli, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/257,455

(22) Filed: Oct. 24, 2008

(51) Int. Cl. G06F 17/14; G06F 12/00

(52) U.S. Cl. 708/404; 708/405; 711/147

(57) ABSTRACT

A system described herein includes a selector component that receives input data that is desirably transformed by way of a Discrete Fourier Transform, wherein the selector component selects one of a plurality of algorithms for computing the Discrete Fourier Transform from a library based at least in part upon a size of the input function. An evaluator component executes the selected one of the plurality of algorithms to compute the Discrete Fourier Transform, wherein the evaluator component causes leverages shared memory of a processor to compute the Discrete Fourier Transform.

### BACKGROUND

The Fast Fourier Transforms (FFT) refers to a class of algorithms for efficiently computing the Discrete Fourier Transform (DFT). The FFT is used in many different fields, including but not limited to physics, astronomy, engineering, applied mathematics, cryptography, and computational finance. In an example application, the FFT can be employed in connection with solving partial differential equations in fluid dynamics, signal processing, and multiplying large polynomials.

Due to the varied uses of the FFT, it has become desirable to implement the FFT in various computing environments. Accordingly, FFT libraries have been implemented for different processors and different Application Programming Interfaces (APIs). Conventional FFT libraries on GPUs, however, may be inflexible in that at least some FFT libraries do not account for different sizes of FFTs or available processor resources. Accordingly, conventional FFT libraries on GPUs are often limited with respect to size of an FFT that can be handled and/or processor performance when an FFT library is employed.

### SUMMARY

The following is a brief summary of subject matter that is described in greater detail herein. This summary is not intended to be limiting as to the scope of the claims.

Various technologies pertaining to computation of DFTs for input data or arbitrary size are described in greater detail herein. Pursuant to an example, a graphics processing unit can include a plurality of multiprocessors, wherein each of the multiprocessors include one or more registers and shared memory. The multiprocessors can be configured to execute threads that are configured to compute a DFT of the input data. As will be described in greater detail herein, the shared memory in the graphics processing unit can be leveraged in connection with computing the DFT. For instance, the shared memory can be used in connection with exchanging data between threads. In another example, the shared memory can be used in connection with storing intermediate computations of one or more threads.

Further, a library of FFT algorithms can be established, wherein the FFT algorithms can be used in connection with directing computation of DFTs on a processing unit. The algorithms can include a global memory algorithm, a shared memory algorithm, and/or a hierarchical memory algorithm. An algorithm for computing a DFT can be selected based at least in part upon size of the input data and processor resources, including a number and size of registers corresponding to a multiprocessor, size of shared memory, amongst other considerations.

Other aspects will be appreciated upon reading and understanding the attached figures and description.

### BRIEF DESCRIPTION OF THE DRAWINGS

FIG. 1 is a functional block diagram of an example system that facilitates computing a DFT.

FIG. 2 is an example depiction of a processor.

FIG. 3 is an example depiction of operation of a processor.

FIG. 4 is a functional block diagram of an example system that facilitates mapping an FFT to a processor.

FIG. 5 is an example Stockham mapping of n DFT.

FIG. 6 is example pseudo-code that can be used in connection with computing an FFT.

FIG. 7 is an example system that facilitates computing a DFT.

FIG. 8 is an example system that facilitates computing a DFT.

FIG. 9 is an example system that facilitates computing a DFT.

FIG. 10 is a flow diagram that illustrates an example methodology for computing a DFT.

FIG. 11 is a flow diagram that illustrates an example methodology for computing a DFT.

FIG. 12 is a flow diagram that illustrates an example methodology for computing a DFT.

FIG. 13 is an example computing system.

### DETAILED DESCRIPTION

Various technologies pertaining to computation of DFTs will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

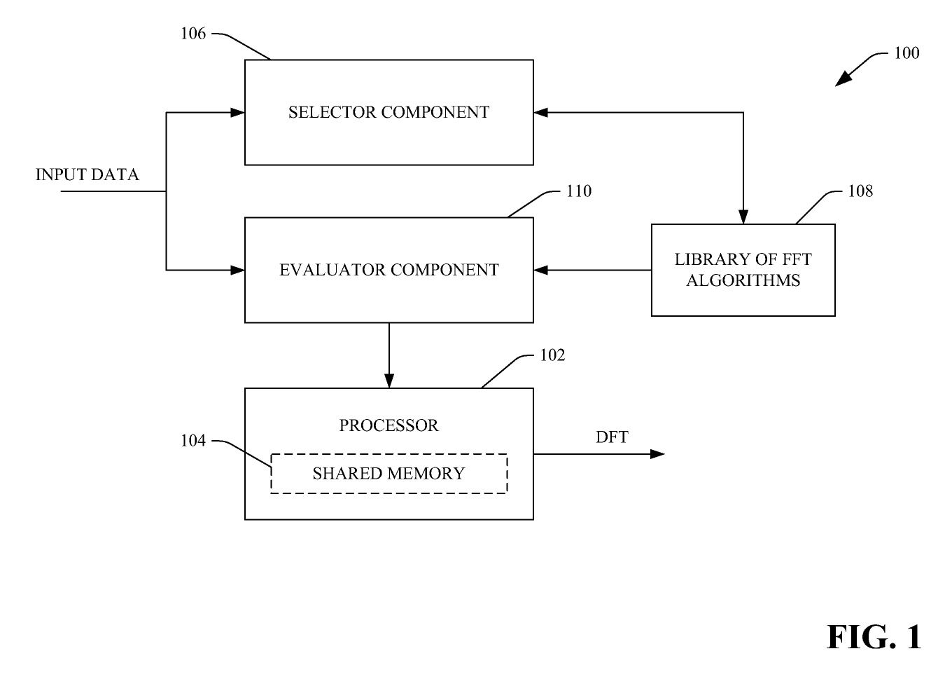

With reference to FIG. 1, an example system 100 that facilitates computing a DFT for input data of arbitrary size is illustrated. The system 100 can, for example, be included in a graphics processing unit or be can be associated with a graphics processing unit. In another example, the system 100 can be included in a central processing unit or can be associated with a central processing unit.

The system 100 includes a processor 102 that can be configured with logic to compute DFTs of input data. The processor 102 can be a graphics processing unit, a central processing unit, or other suitable processing device. As will be shown and described in greater detail herein, the processor 102 can include shared memory 104, wherein the shared memory 104 can be memory that is shared between scalar processors in a multiprocessor within the processor 102, and can be explicitly controlled memory and/or cache memory.

The system 100 can also include a selector component 106 that receives input data that is desirably transformed by way of a DFT. For instance, the input data can be of one particular radix or mixed radix. The input data can be provided by a user, can be provided by an application as part of a larger problem (e.g., as part of a problem domain), etc.

The system 100 can additionally include a library of FFTs 108, wherein the library of FFTs 108 can include a plurality of algorithms that can be used in connection with computing DFTs on the processor 102. In other words, the processor 102 can be configured to compute a DFT with respect to the input data using one or more of the algorithms in the library of FFTs 108. Pursuant to an example, the library of FFTs 108 can include a global memory FFT algorithm, a shared memory FFT algorithm, and a hierarchical FFT algorithm. In addition, the library of FFTs 108 can include a mixed-radix FFT algorithm, a Bluestein FFT algorithm, a multi-dimensional FFT algorithm, and/or a real FFT algorithm, wherein such algorithms may be based at least in part upon the global memory FFT algorithm, the shared memory FFT algorithm, and/or the hierarchical FFT algorithm.

The selector component 106 can access the library of FFTs 108 in response to receiving the input data, and can select an FFT algorithm from the library of FFTs 108 based at least in part upon size of the input data and/or characteristics of the processor 102. For instance, size of the input data can be a number of terms in a complex sequence that is desirably transformed by way of a DFT, and resources of the processor 102 can include size of the shared memory 104, number of registers corresponding to a multiprocessor, etc.

The system 100 can additionally include an evaluator component 110 that can execute the algorithm selected by the selector component 106 to compute the DFT with respect to the input data. The evaluator component 110 can cause at least a portion of the DFT to be computed using the shared memory 104 of the processor 102. Furthermore, while the selector component 106 and the evaluator component 110 are shown as being external to the processor 102, it is to be understood that one or both of such components can be included in the processor 102. Moreover, the library of FFTs 108 can be included in memory of the processor 102.

For purposes of explanation, naïve computation of a DFT is described herein. An FFT refers to a class of algorithms for efficiently computing the DFT of a complex data sequence. The DFT of a complex sequence x=x₀, . . . ,x_{N-1} is an N-point complex sequence, X=X₀, . . . ,X_{N-1}, where

$${X}_{k} = {\sum }_{j = 0}^{N - 1} {x}_{j} {e}^{- 2 π ij k / N} .$$

The inverse DFT is similarly defined as

$${x}_{k} = \frac{1}{N} {\sum }_{j = 0}^{N - 1} {X}_{j} {e}^{2 π i j k / N} .$$

A naïve implementation of DFTs requires O(N)² operations and can be computationally expensive. FFT algorithms compute the DFT in O(N log N) operations. Furthermore, due to a lower number of floating point computations per element, the FFT can also have higher accuracy than a naïve DFT. As noted above, the processor 102 can execute an FFT algorithm from the library of FFTs 108 and can compute a DFT for the input data using the shared memory 104.

Pursuant to an example, and as will be described in greater detail below, the evaluator component 110 can configured to execute Bluestein's Fast Fourier Transform algorithm when the input data is a non-power of two size. Further, the evaluator component 110 can be configured to employ modular arithmetic in Bluestein's Fast Fourier Transform algorithm to facilitate improving numerical accuracy of the computed Discrete Fourier Transform.

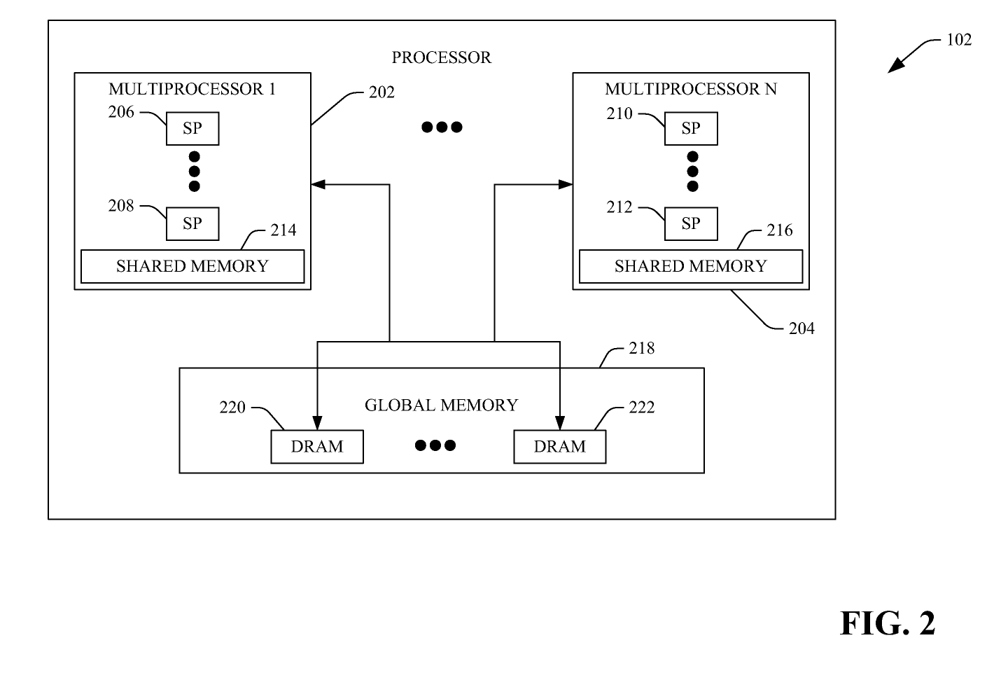

Referring now to FIG. 2, an example depiction of the processor 102 is illustrated. The processor 102 includes a plurality of multiprocessors 202-204. In an example, the processor 102 can include eight multiprocessors. Each multiprocessor in the processor 102 can include a plurality of scalar, in order processors 206-212. As shown herein, the multiprocessor 202 includes scalar processors 206-208, and the multiprocessor 204 includes the scalar processors 210-212. In an example, each multiprocessor can include sixteen scalar processors. Furthermore, each multiprocessor can additionally include a shared memory. As shown, the multiprocessor 202 includes a shared memory 214, and the multiprocessor 204 includes a shared memory 216. Shared memory in a multiprocessor can be employed in connection with communication between threads executing on scalar processors in the multiprocessor, and can be organized into several banks. Furthermore, while not shown, each multiprocessor can include one or more program registers. The processor 102 can further include a global memory 218, which can include a plurality of Dynamic Random Access Memory (DRAM) memory banks 220-222. In an example, the global memory 218 can include six DRAM memory banks.

The scalar processors 206-212 can be employed in connection with executing a program in parallel using threads. As noted, the scalar processors 206-212 can be grouped together into multiprocessors. A multiprocessor can include several fine-grain hardware thread contexts, and at any given moment, a group of threads (herein referred to as a warp) can execute on the multiprocessor in lock-step. When several warps are scheduled on a multiprocessor, latencies corresponding to the global memory 218 and pipeline stalls can be hidden by switching to another warp. Still further, each multiprocessor in the processor 102 can include a register file, and during execution program registers can be allocated to threads scheduled on a multiprocessor. As noted above and as will be described in greater detail herein, the global memory 218 and the shared memory 214-216 can be leveraged when computing DFTs.

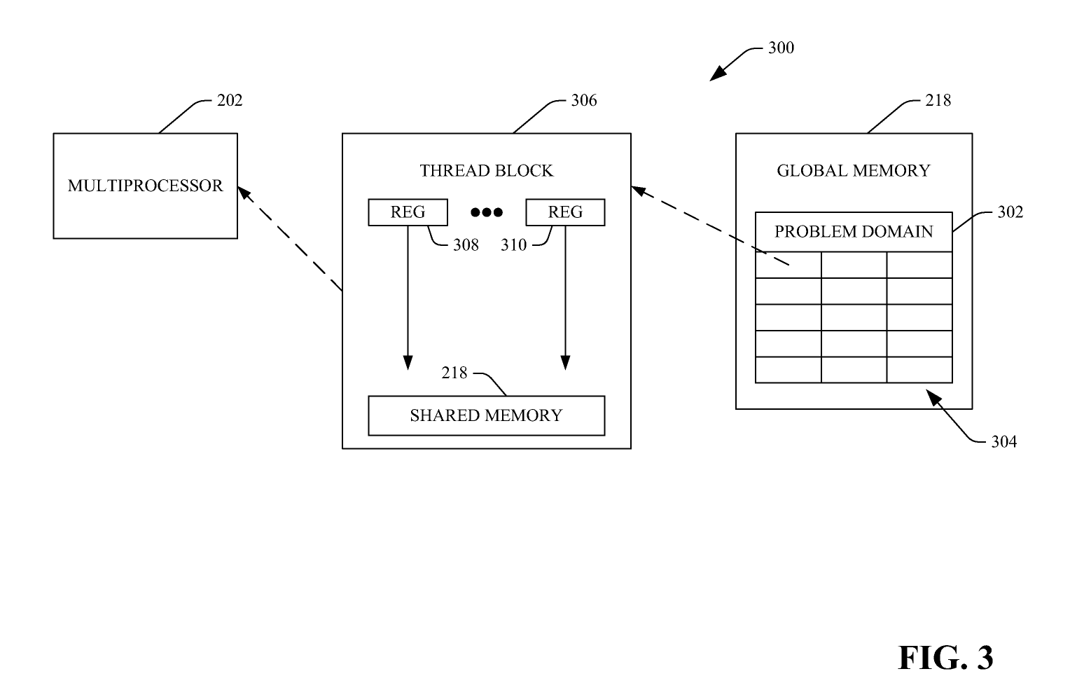

Referring now to FIG. 3, an example depiction 300 of a computation on the processor 102 is illustrated. The depiction 300 includes the global memory 218 and the multiprocessor 202. In operation, a portion of the global memory 218 can be allocated for data, and an application can be specified, wherein the application is configured to execute on the multiprocessor 202 (and other multiprocessors in the processor 102) with respect to data allocated in the global memory 218. To execute the program on a problem domain 302, the domain 302 can be decomposed into a plurality of blocks 304.

A thread execution manager (not shown) can assign threads to operate on the blocks 304. A thread block 306 is shown, wherein the thread block 306 can include a plurality of threads that are assigned to execute on the multiprocessor 202. The thread block 306 illustrates that the multiprocessor 202 includes a register file that comprises a plurality of program registers 308-310, wherein data can be exchanged between threads through use of the program registers 308-310 and the shared memory 214. Output of threads in the thread block 306 can be transferred to the global memory 218.

FIGS. 2 and 3 illustrate a particular processor architecture and execution of threads with respect to such architecture. The following discussion regarding computing DFTs through leveraging global memory, shared memory, and registers uses the described processor architecture. It is to be understood, however, that DFTs can be computed as described herein using other similar processor architectures, and that the claims are not intended to be limited by the description of the processor architecture and operation shown in FIGS. 2 and 3.

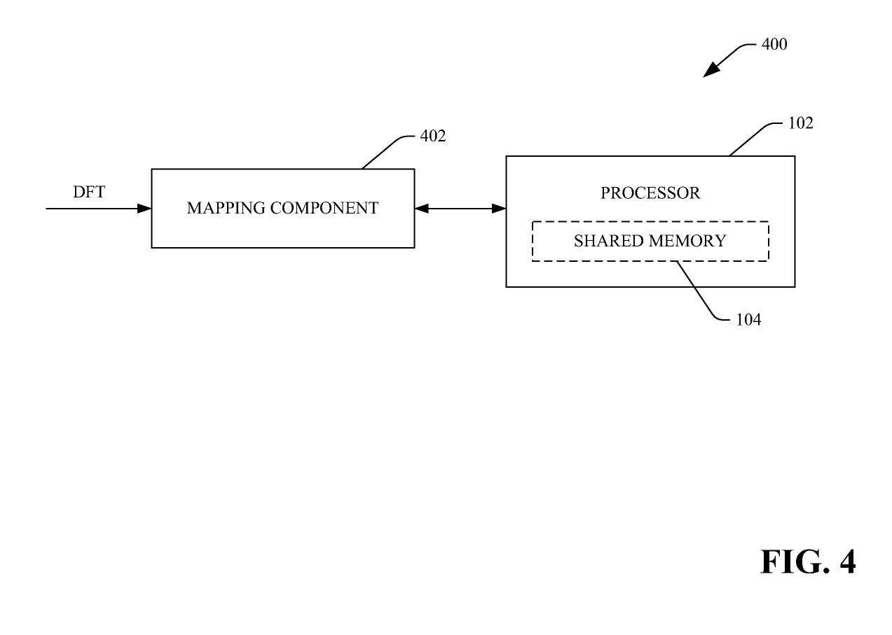

With reference now to FIG. 4, an example system 400 that facilitates mapping DFTs to the processor 102 is illustrated. The system 400 includes a mapping component 402 that can receive a desirably computed DFT and map it to the processor 102. In an example, the mapping component 402 can perform a Stockham formulation of the DFT in connection with mapping the DFT to the processor 102.

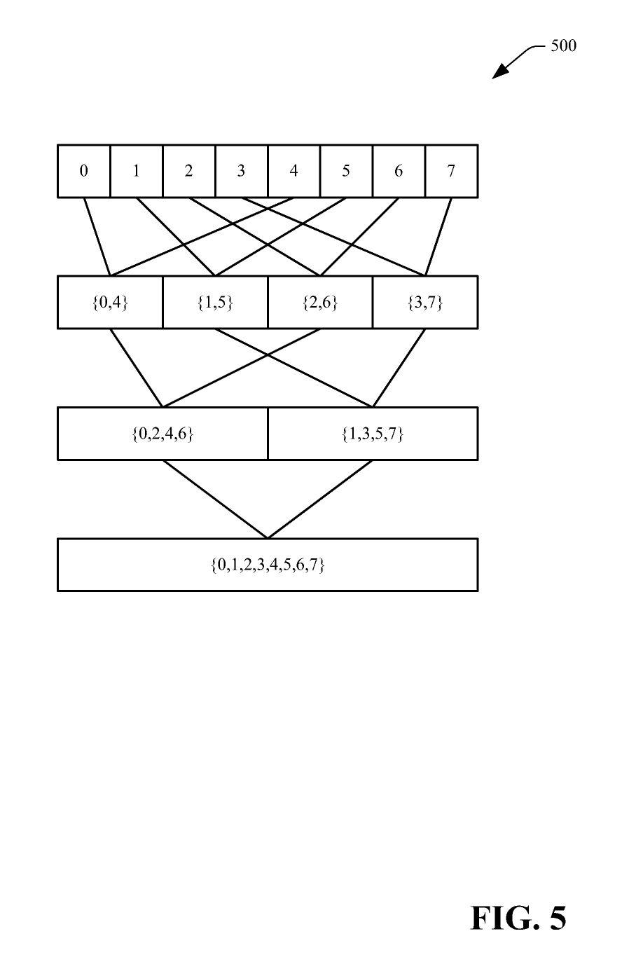

In an example, the processor 102 can be a GPU. Performance of FFT algorithms can depend heavily on the design of the memory subsystem and how well the design is exploited. Although GPUs provide a high degree of memory parallelism, the index-shuffling stage (also referred to as bit-reversal for radix-2) of FFT algorithms such as Cooley-Tukey can be expensive due to incoherent memory access. The mapping component 402 can perform the Stockham formulation of the FFT to avoid the index-shuffling stage. This, however, can require that the FFT be performed out of place. An example of a known radix-2 Stockham FFT algorithm that can be employed by the mapping component 402 is depicted generally in FIG. 5.

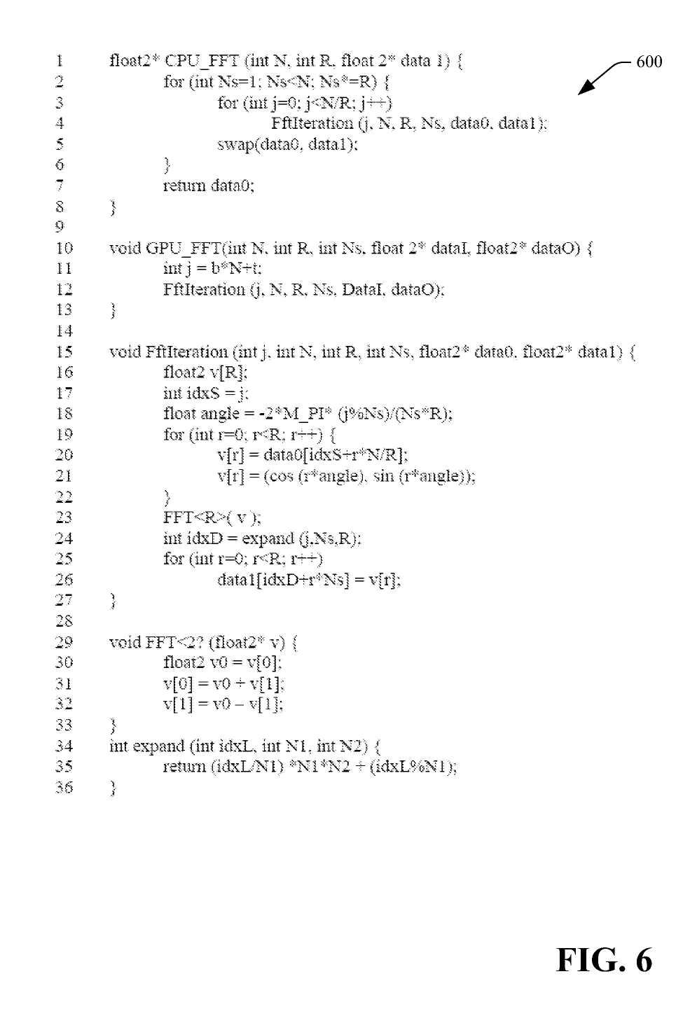

With reference now to FIG. 6, example pseudo-code 600 that can be used by the evaluator component 110, the mapper component 402, and/or the processor 102 in connection with mapping DFTs to the processor 102 and/or computing the DFT of input data is illustrated. For instance, FIG. 6 can depict a reference implementation of a radix-R Stockham algorithm, wherein each iteration over the input data combines R subarrays of length N_{S} into arrays of length RN_{S}. The iterations can stop when the entire array of length N is obtained. The data can be read from global memory and scaled by twiddle factors (lines 17-22), combined using an R-point FFT (line 23), and written back to the global memory (lines 24-26). The expand ( ) function can be thought of as inserting a dimension of length N₂ after the first dimension of length N₁ in a linearized index.

The pseudo-code of FIG. 6 is provided merely as an example, and other variations are contemplated. The example pseudo code 600 is configured to perform a Stockham radix-R FFT with a specialization for radix-2. In each iteration, the pseudo code 600 can be thought of as combining the R FFTs on subsequences of length N_{S} into the FFT of a new sequence of length RN_{S} by performing an FFT of length R on the corresponding elements of the subsequences.

Performance of traditional general purpose GPU implementations of DFTs using graphics APIs, for instance, can be limited by a lack of scatter operations (as shown in the function CPU_FFT in the example pseudo-code 600). In other words, a thread cannot write to an arbitrary location in global memory. The above-example pseudo code writes to R different locations each iteration (line 26). Without availability of scatter operations, R values must be read for each output generated rather than reading R values for every R outputs. GPUs and APIs that support writing multiple values to the same location in multiple buffers can save redundant reads, but must either use more complex indexing when accessing the values written in a preceding iteration, or after each iteration, they must copy the values to their proper location in a separate pass, which consumes bandwidth. Thus, scatter operations can be utilized in connection with conserving memory bandwidth.

The example pseudo-code 600 additionally illustrates functionality for an implementation of the DFT on a GPU which supports scatter operations. A difference between GPU_FFT ( ) and CPU_FFT ( ) is that the index j into the input data is generated as a function of the thread number t in the group of threads assigned to a multiprocessor, the block index b (the index of the thread block assigned to the multiprocessor), and the number of threads per block T (line 11). Additionally, the iteration over values of N_{S} can be generated by multiple invocations of GPU_FFT ( ) rather than in a loop (line 2) because a global synchronization between threads may be needed between the iterations, and for many GPUs the only global synchronization is kernel termination.

For each invocation of GPU_FFT ( ), T can be set to N/R and a number of thread blocks B can be set to M, where M can be a number of FFTs desirably processed simultaneously. Thus, the mapping component 402 can map multiple DFTs to the processor 102, and the processor 102 can process multiple DFTs at a substantially similar time. Processing multiple DFTs at a substantially similar time can be beneficial as the number of warps used for a small-sized DFT may not be sufficient to achieve full utilization of a multiprocessor or to hide memory latency while accessing the global memory 218.

While the function GPU_FFT ( ) in the pseudo-code 600 utilizes the scatter operation, a number of performance issues may remain. For instance, writes to the global memory 218 of the processor 102 may have coalescing issues. For instance, the memory subsystem of the processor 102 may attempt to coalesce memory accesses from multiple threads into a smaller number of accesses to larger blocks of memory. Space between consecutive accesses generated during a first few iterations (e.g., a small N_{S}) may be too large for coalescing to be effective (line 26). In addition, the pseudo-code 600 does not exploit low-latency shared memory to improve data re-use. This can also be problematic for traditionally general purpose GPU implementations, as graphics APIs fail to provide access to the shared memory 104 in the processor 102. In addition, the pseudo-code 600 may not appropriately handle arbitrary lengths with respect to the input data, as a separate specialization may be needed for all possible radices R.

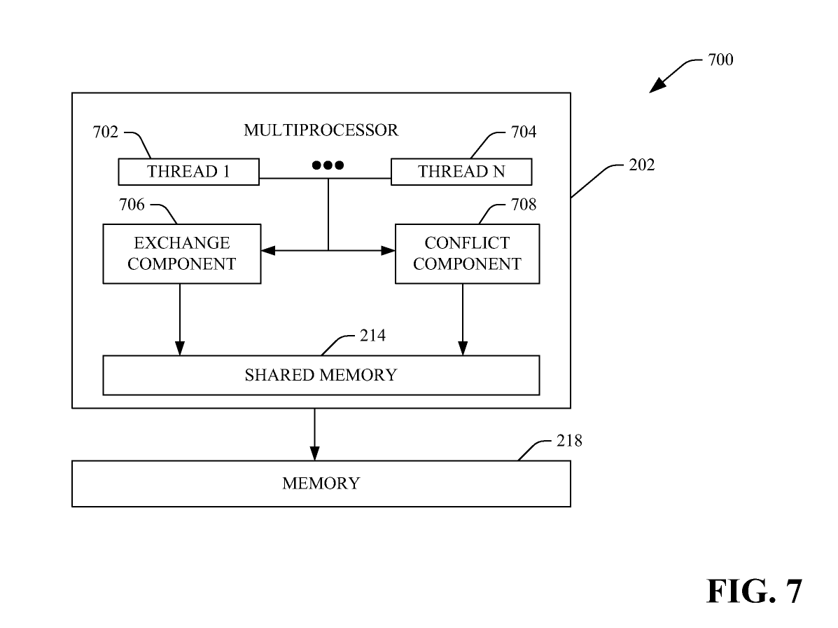

Referring now to FIG. 7, a system 700 that facilitates computing DFTs is illustrated. More particularly, the system 700 can be used in connection with implementing a global FFT algorithm, wherein interim results when computing a DFT can be written to global memory of a processor. The system 700 can be particularly well-suited for computing DFTs of relatively large input data with higher radices on processor architectures with relatively high memory bandwidth. The system 700 includes the multiprocessor 202, which includes the shared memory 214. The multiprocessor 202 is operatively coupled to the global memory 218. A plurality of threads 702-704 can execute on the multiprocessor 202. The multiprocessor 202 can additionally include an exchange component 706 that can be configured to exchange data between the threads 702-704 through use of the shared memory 214, such that data can be written out in relatively large contiguous segments to the global memory 218. The multiprocessor 202 can additionally include a conflict component 708 which can be used in connection with preventing conflicts between banks in the shared memory 214. The exchange component 706 and the conflict component 708 will be described in greater detail herein.

As noted above, the pseudo-code for GPU_FFT ( ) (FIG. 6) can lead to sub-optimal memory access for coalescing, which can reduce performance. On some processors (e.g., GPUs), rules for memory access coalescing can be stringent. Memory accesses to the global memory 218 can be coalesced for groups of CW threads at a time, where CW is a coalescing width. For instance, CW can be sixteen. Pursuant to an example, coalescing can be performed when each thread in the group of CW threads access either a 32-bit, 64-bit, or 128-bit word in sequential order and the address of the first thread in the group of CW threads is aligned to (CW×word size). Bandwidth for non-coalesced accesses can be about an order of magnitude slower when compared to bandwidth for coalesced accesses. It is to be understood, however, that some processors have more relaxed coalescing requirements.

In an example, coalescing can be performed for any access pattern, so long as the threads in the group of CW threads access a same word size. The hardware of the processor 102 can issue memory transactions in blocks of 32, 64, or 128 bytes while seeking to minimize a number and size of transactions to the global memory 218 to satisfy the requests. For both sets of coalescing requirements, greatest bandwidth can be achieved when accesses to the global memory 218 are contiguous and properly aligned.

If a number of threads per thread block (FIG. 3) T=N/R is no less than CW, the mapping component 402 (FIG. 4) that maps threads to elements in the Stockham formulation can cause reads from the global memory 220 to be in contiguous segments of at least CW in length (line 20 of the pseudo-code 600 shown in FIG. 6). If the radix R of the input data is a power of two, reads to the global memory 218 are additionally aligned properly. Writes to the global memory 218, however, may not be contiguous for the first [log_{R} CW] iterations where N_{S}<CW (line 26 of the pseudo-code 600 of FIG. 6). It can be discerned, however, that under the assumption that T≧CW, when all writes to the global memory 218 have been completed, the areas of the global memory 218 affected do contain contiguous segments of sufficient length.

The exchange component 706 can handle the aforementioned problem with writing to the global memory 218 by first exchanging data between the threads 702-704 using the shared memory 214, such that data can be written out in larger contiguous segments to the global memory 218. The example pseudo-code below can be used in connection with the pseudo-code 600 to facilitate using the shared memory 214 to exchange data between threads. More particularly, lines 25 and 26 of the pseudo-code 600 can be replaced with the following example pseudo-code:

1 int idxD = (t/Ns)*R+ (t%Ns);
2 exchange (v, R, 1, idxD, Ns, t, T)
3 idxD = b*T*R +t;
4 for (int r=0; r<R; r++)
5 data [idxD+r*T] = v[r];

Example pseudo-code for the function exchange ( ) can be found below:

1 void exchange (float2* v, int R, int stride, int idxD, int
2 incD, int idxS, int incS) {
3 float* sr = shared, *si = shared+T*R;
4 _syncthreads ( );
5 for (int r=0; r<R; r++) {
6 int i = (idxD + r*incD)*stride;
7 (sr[i], si[i]) = v[r];
8 }
9 _syncthreads( );
10 for (r=0; r<R; r++) {
11 int i = (incS + r*incS)*stride;
12 v[r] = (sr[i], si[i]);
13 }
14 }

The exchange component 706 can be configured to select the radix R, wherein the size of R can be limited by a number of registers in the multiprocessor 202 and the amount of shared memory 214 that is used. For instance, reducing a number of threads reduces a total number of registers and an amount of shared memory used, but with too few threads memory latency may be problematic. Pursuant to an example, a number of threads can be set at T=max ([64]_{R}_{ⁱ},N/R), where [x]_{R}_{ⁱ} can represent a smallest power of R not less than x.

The conflict component 708 can pad a particular number of empty values between a set of sixteen values in the shared memory 214 to avoid conflicts. In more detail, the shared memory 214 can be organized into 16 banks with 32-bit words distributed round-robin between the banks. Accesses to the shared memory 214 can be serviced for groups of 16 threads at a time (e.g., half-warps). If any of the threads in a half-warp access the same memory bank at the same time, a conflict occurs, which degrades performance.

As can be discerned, to avoid bank conflicts in the shared memory 214, the example exchange ( ) function writes real and imaginary components to separate arrays with stride 1 (instead of a single array of float2). When a float2 is written to the shared memory 214, the real and imaginary components are written separately with a stride 2, which can result in bank conflicts in the shared memory 214. In addition, a call to exchange ( ) can result in bank conflicts when R is a power of two and N_{S}<16. The conflict component 708 can pad with N_{S} empty values between every 16 values. For R=2, the cost of computing padded indexes can outweigh benefit of avoiding bank conflicts, but for radix-4 and radix-8, the net gain can be significant. In addition, padding can require extra shared memory—to reduce an amount of shared memory by a factor of 2, the conflict component 708 can cause one component to be exchanged between threads at a time (e.g., real or imaginary). Exchanging one component at a time can require three synchronizations instead of one, but can result in a net gain in performance because more in-flight threads are allowed. Padding may not be necessary when R is odd because R may be relatively prime with respect to the number of banks in the shared memory 214.

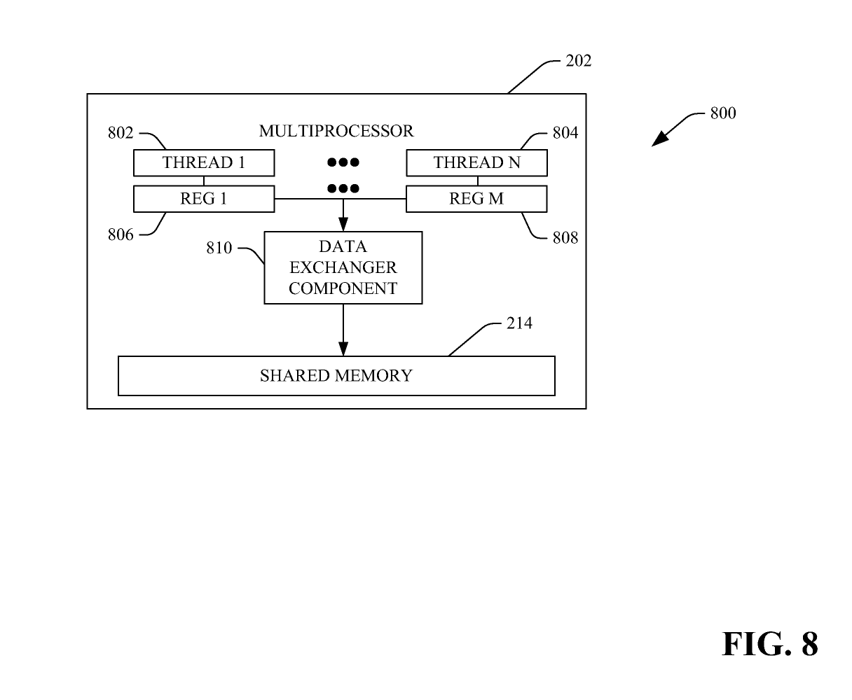

Referring now to FIG. 8, a system 800 that facilitates computing DFTs is illustrated. More particularly, the system 800 can be used in connection with implementing a shared memory FFT algorithm, wherein an entire DFT can be computed using only shared memory and registers (without writing intermediate results to global memory). The system 800 can be particularly well-suited for computing DFTs of relatively small input data (e.g., a relatively small N). The system 800 includes the multiprocessor 202, which includes the shared memory 214. A plurality of threads 802-804 can be assigned to execute on the multiprocessor 202, wherein the plurality of threads are configured to compute a DFT for input data.

The system 800 additionally includes a plurality of registers 806-808. In some processor architectures, there may be a large number of registers relative to size of the shared memory 214. This can be exploited to increase performance. The registers 806-808 can be used to store data held by the threads 802-804 (in an array v), and thus each iteration of a DFT computation can be undertaken without reading or writing data to global memory. The system 800 additionally includes a data exchanger component 810, which can be employed in connection with exchanging data between registers of different threads. In an example, the shared memory 214 can be used solely to exchange data between the registers 806-808. In another example, the shared memory 214 can be employed in connection with retaining data held by the threads 802-804 (e.g., if a number of the registers 806-808 is relatively small). Still further, the shared memory 214 can be employed to retain intermediate results of a DFT computation.

Shown below is example pseudo-code for computing a DFT in accordance with the shared memory algorithm. Such pseudo-code can be used when N is small enough that an entire DFT can be performed just using shared memory and registers.

1 templated<int R> void
2 FftShMem (int sign, int N, float2* data) {
3 float2 v[R];
4 int idxG = b*N+t;
5 for (int r=0; r<R; r++)
6 v[r] = data[idxG +r*T];
7 if (T==N/R)
8 DoFft (v, R, N, t);
9 else {
10 int idx = expand (t.v, N/R, R);
11 exchange (v, R, 1, idx, N/R, t, T);
12 DoFft (v, R, N, t);
13 exchange(v, R, 1, t, T, idx, N/R);
14 }
15 float s = (sign <1) ? 1 : 1.0/N;
16 for (int r = 0; r<R; r++)
17 data [idxG + r*T] = s*v[r];
18 }
19
20 void DoFFt(float2* v, int R, int N, int j, int stride=1) {
21 for (int Ns=1; Ns<N; Ns*=R) {
22 float angle = sign*2*M_PI* (j%Ns)/(Ns*R);
23 for (int r=0; r<R, r++)
24 v[r] *= (cos (r*angle), sin (r*angle));
25 FFT<R>(v);
26 int idxD = expand (j, Ns, R);
27 int idxS = expand (j, N/R, R);
28 exchange (v, R, stride, idxD, Ns, idxS, N/R);
29 }
30 }

Pursuant to an example, the number of threads can be T=max([64]_{R}_{ⁱ},N/R). Lower bounds on a number of threads can ensure that when data is read from global memory (lines 4-6 in the above example pseudo-code), the data will be read in contiguous segments greater than CW in length. When T>N/R, however, the data exchanger component 810 can exchange data between threads. In this case, the pseudo-code can be used to compute more than one DFT at a time and a number of thread blocks employed can be reduced accordingly. Data may then be restored to its original order to produce relatively large contiguous segments when written back to global memory. When T=N/R, data may not be exchanged after reading from global memory. Furthermore, the DFT can be performed in place as data may be written back to a same location from which the data was read. In addition, while not shown, the system 800 can include the conflict component 708 (FIG. 7), which can perform padding to avoid bank conflicts in the shared memory 214.

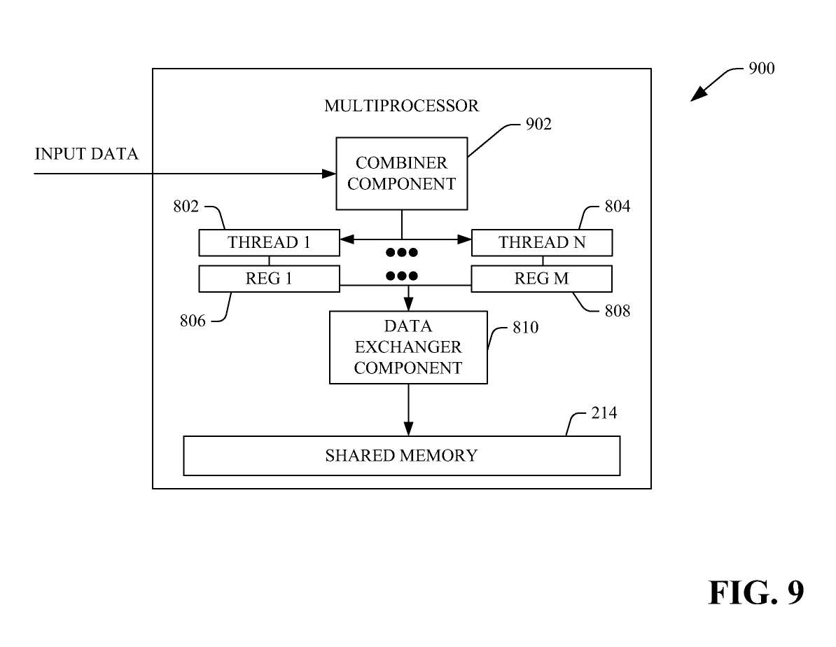

Now referring to FIG. 9, an example system 900 that facilitates computing DFTs on input data is illustrated. The system 900 may be particularly well-suited for computing DFTs of input data of relatively large size. More particularly, the system 900 can be used in connection with implementing a hierarchical FFT algorithm. The system 900 includes the multiprocessor 202, which comprises the shared memory 214. The system 900 additionally includes a combiner component 902, which is configured to combine DFTs of subsequences that are small enough to be handled in the shared memory 214, wherein the threads 806-808 can act on the subsequences. Operation of the combiner component 902 can be analogous to how the shared memory algorithm (described above with respect to FIG. 8) computes a DFT of length N by utilizing multiple DFTs of length R that are performed entirely in the registers 806-808. The system 900 additionally includes the registers 806-808 and the data exchanger component 810, which can act as described above with respect to FIG. 8.

For purposes of explanation, an array of input data A of length N=N_{α}N_{β} can be received. Given such array, the following hierarchical FFT algorithm can be considered: 1) A can be treated as an N_{α}×N_{β} array (row-major), and N_{α} DFTs of size N_{β} can be performed along the columns; 2) each element Aᵢⱼ in the array can be multiplied with twiddle factors ω=e^{±2πij/N} (e.g.,—for forward transforms, + for the inverse); 3) N₂ DFTs of size N_{α} can be performed along the rows; and 4) A can be transposed from N_{α}×N_{β} to N_{β}×N_{α}. N_{β} can be chosen to be small enough that the DFT can be performed in the shared memory 214. If N_{α} is too large to fit into the shared memory 214, the above algorithm can recurse, such that each row of length N_{α} can be treated as an N_{αα}×N_{αβ} array, etc. In other words, the above algorithm can wrap an original one dimensional array of length N into multiple dimensions, each small enough that the DFT can be performed in the shared memory 214 along that dimension. The dimension can then be transformed from highest to lowest. An effect of the multiple transposes that occur when exiting the recursion is to reverse the order of the dimensions, which is analogous to bit-reversal.

Example pseudo-code for implementing the above algorithm (including performing the DFT, the twiddle, and the transpose) is provided below:

1 template<int R> void
2 FftShMemCol (int sign, int N, int strideO, float 2* dataI,
3 float2* dataO) {
4 float2 v[R];
5 int strideI = B.x*T.x;
6 int idxI = (((b.y*N+t.y)*B.x+b.x)*T.x)+t.x;
7 int incI = T.y*strideI;
8 for (int r=0; r<R; r++)
9 v[r] = data[idxI + r*incI];
10 DoFft (x, R, N, t.y, T.x);
11 if (strideO < strideI) {
12 int i = t.y, j = (idxI%strideI)/strideO;
13 angle = sign*2*M_PI*j/(N*strideI/strideO);
14 for (int r=0; r<R; r++) {
15 v[r] *= (cos(i*angle), sin(i*angle));
16 i += T.y;
17 }
18 }
19 int incO = T.y*strideO;
20 int idxO = b.y*R*incI + expand (idxI%incI, incO, R);
21 if (strideO == 1) {
22 int idxD = t.x*N +t.y;
23 int idxS = t.y*T.x +t.x;
24 incO = T.y*T.x;
25 idxO = (b.y*B.x+b.x)*N + idxS;
26 exchange (v,R,1, idxD,T.y, idxS, incO);
27 }
28 float x = (sign < 1) ? 1 : 1.0/N
29 for (int r=0; r<R; r++)
30 data[idxO + r*incO] = s*v[r];
31 }

The above pseudo-code is implemented under the assumption that stride I (the stride between elements in a sequence and the product of the dimensions preceding the one transformed) is greater than one and that the product of all the dimensions is a power of R. Data accesses to global memory for a single DFT along a dimension greater than one may not be contiguous. To obtain contiguous access, a block of M_{b} sequences can be performed at a substantially similar point in time, where M_{b} is a power of R no smaller than CW.

Special handling may be desirable in cases where the strides of sequence elements on input and output strideI or strideO are less than M_{b}. When strideI≧M_{b} and strideO=1, data in the shared memory 214 can be rearranged such that the data can be written out to global memory in large contiguous segments (e.g., lines 23-27 of the example pseudo-code). In an example, strideI may be one if the preceding dimensions have a trivial length of 1, in which case the shared memory algorithm described previously can be used to compute the DFT. For other cases, specialized code can be used to handle reading and writing of partial memory blocks.

The systems/algorithms described above can additionally be utilized in connection with computing a mixed-radix FFT, Bluestein's FFT, multi-dimensional FFTs, real FFTs, and discrete cosine transforms. More particularly, FIGS. 7-9 have been described in connection with mapping radix-R FFT algorithms, for which N=Rⁱ, to a processor. To handle mixed-radix lengths N=R₀^{a}R₁^{b}, a value used for R can be varied in the iterations of a radix-R algorithm. For example, for N=2^{a}3^{b}, a iterations can be run with R=2 and b iterations can be run with R=3 using either global or shared memory FFTs (described above with respect to FIG. 7 and FIG. 8, respectively). If 2^{a} and 3^{b} are small enough to fit in shared memory, but N is too large, the computation can be performed hierarchically (e.g., as described with respect to FIG. 9) by setting N_{α}=2^{a} and N_{β}=3^{b}. Specializations of FFT<R> can be manually optimized for smaller primes. When N is a composite of large primes, Bluestein's FFT can be used.

The Bluestein's FFT algorithm computes the DFT of arbitrary length N by expresseing it as a convolution of two subsequences a and b:

$${X}_{k} = {b}_{k}^{*} {\sum }_{j = 0}^{N - 1} {a}_{j} {b}_{k - j}$$

where

$${b}_{j} = {e}^{\frac{{πij}^{2}}{N}} ,$$

aⱼ=xⱼ·b*ⱼ, where the * operator represent conjugation. The convolution can be computed efficiently as the inverse FFT of A·B, where A and B are FFTs of a and b, respectively. The FFTs can be of any length not smaller than 2N−1. For instance, an optimized radix-R FFT can be used. In order to improve performance for small sequences, an entire convolution can be performed in shared memory (e.g., described above with respect to FIG. 8).

When N is large, inaccuracy can arise in the computation of bⱼ. Because e^{2πix} is periodic, b^{j} can be rewritten as

$${e}^{2 π i \frac{{j}^{2}}{2 N}} = {e}^{2 π i f} = {e}^{2 π i frac ( f )} ,$$

where f=j²/(2N) and frac(f)=f−└f┘. It can be ascertained that bⱼ may be inaccurate when f is so large that few, if any, bits are used for its fractional component. To overcome such issue, f can be refined by discarding larger integer components. For instance, f′=rm/(2N) can be computed, where rm=j² mod 2N. It can be assumed that N ∈ [0, 2³⁰), which would require over 2³⁵B, or 32GiB, to compute the DFT with a power-of-two FFT (2 buffers with 2³¹ elements for A and B with 8 bytes per element), which may be above memory capacities of current processors. Accordingly, rm can be estimated as follows:

rm=j²−2N└f┘,

where f can be calculated using 32-bit floating point arithmetic. For instance, since some of the current GPUs do not yet have 64-bit arithmetic, it can be assumed that j²=aₕ2³²+aₗ and 2N└f┘=bₕ2³²+bₗ, where aₕ, aₗ, bₕ, and bₗ are all unsigned 32-bit integers. The lower 32 bits of the multiplications, aₗ and bₗ, using standard unsigned multiplication. To obtain the upper 32 bits, aₕ and bₕ, an intrinsic umulhi ( ) can be employed. f′ may then be computed using modular arithmetic:

$${f}^{′} = frac ( ( {a}_{h} - {b}_{h} ) \frac{{2}^{32} mod 2 N}{2 N} ) + \frac{( {a}_{l} - {b}_{l} ) mod 2 N}{2 N} .$$

Such process can be generalized to support a larger N if desired. Further, the 2³²mod 2N can be pre-computed where 64-bit arithmetic is available.

In addition, multi-dimensional DFTs can be implemented by performing DFTs independently along each dimension. Performance, however, tends to degrade for higher dimensions where the stride between sequence elements is large. This can sometimes be overcome by first transposing the data to move the highest dimension down to the lowest dimension before performing the DFT. This process can be repeated to cycle through all the dimensions. By using pseudo-code like that described with respect to FIG. 8 (which combines the DFT with a transpose), separate transpose passes over the data can be avoided.

Furthermore, as noted above, real FFTs and DCTs can be computed using the algorithms described with respect to FIGS. 7-9. FFTs of real sequences have special symmetry, wherein such symmetry can be used to transform a real FFT into a complex FFT of half of the size of the real FFT. Similarly, trigonometric transforms, such as the DCT can be implemented with complex FFTs through simple transformation on the data. Real FFTs and DCTs can be implemented with wrapper functions around the FFT algorithms presented with respect to FIGS. 7-9.

The above algorithms can be implemented with various parameters. In an example, the above algorithms can be configured to use radix-8 for as many iterations as possible, and when N is not divisible by 8, radix-2 or radix-4 can be used for a last iteration. Furthermore, various optimization techniques can be employed. In an example, constant propagation can be used to optimize the above-described algorithms. Templates can be used to implement specialized kernels for a number of different thread counts. In addition, bit-wise operations can be used to implement larger multiply, divide, and modulus for power-of-two-radices. Computation may be reduced by computing values common to all threads in a block using a single thread and storing such values in shared memory. Input limits to threads can be modified by way of virtualizing. Thread indices can be virtualized by adding loops in kernels so that a single thread does the work of multiple virtual threads. Thread blocks can be virtualized by invoking the kernel multiple times and adding and appropriate offset to the thread block index for each invocation.

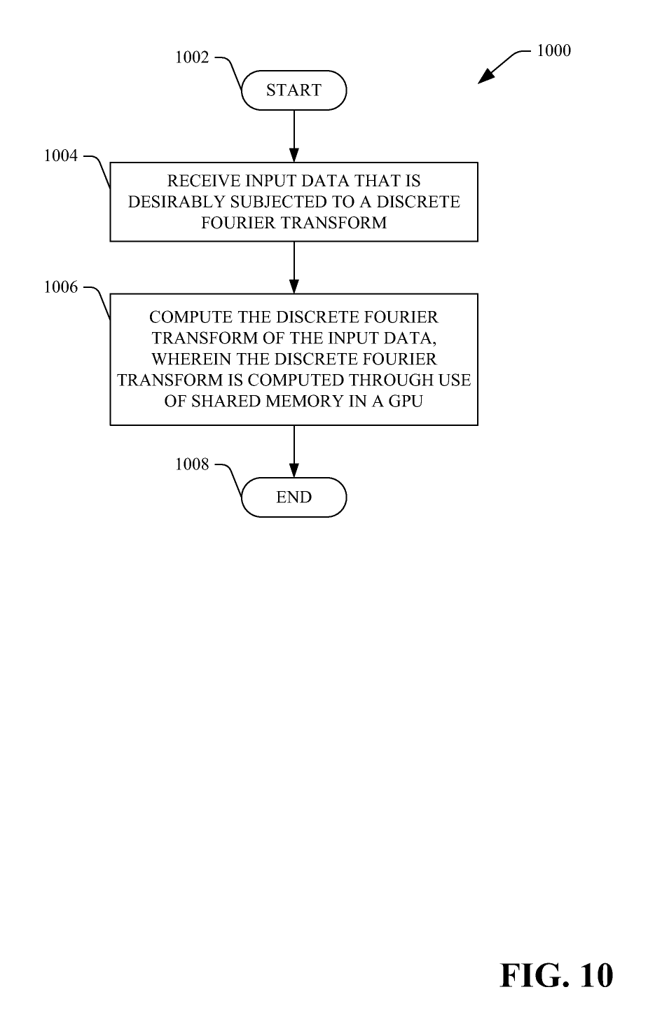

With reference now to FIGS. 10-12, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring now to FIG. 10, a methodology 1000 that facilitates computing a DFT on input data is illustrated. The methodology 1000 begins at 1002, and at 1004 input data is received that is desirably subject to a DFT. At 1006, the Discrete Fourier Transform of the input data is computed, wherein the Discrete Fourier Transform is computed through use of shared memory in a graphics processing unit. Pursuant to an example, the global memory FFT algorithm, the shared memory FFT algorithm, and/or the hierarchical memory FFT algorithm uses shared memory of a processor to compute DFTs. The methodology 1000 completes at 1008.

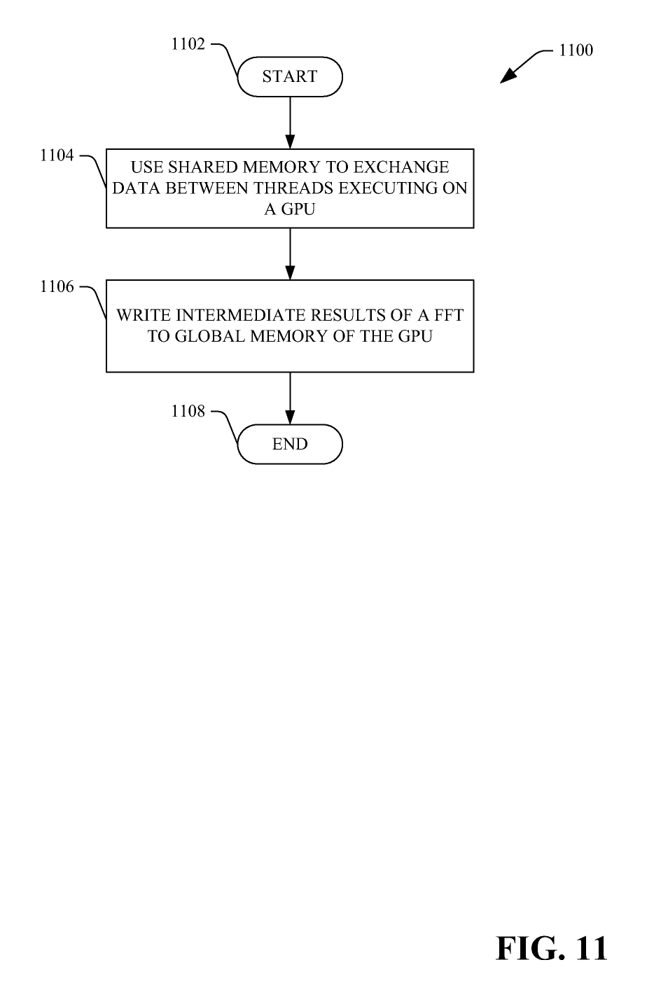

Turning now to FIG. 11, an example methodology 1100 for computing a DFT of input data is illustrated. The methodology 1100 starts at 1102, and at 1104 shared memory on a GPU is used to exchange data between threads executing on the GPU, wherein the threads can be configured to compute at least a portion of the Fast Fourier Transform on the input data. At 1106, intermediate results of the FFT are written to global memory of the graphics processor. The methodology 1100 completes at 1108.

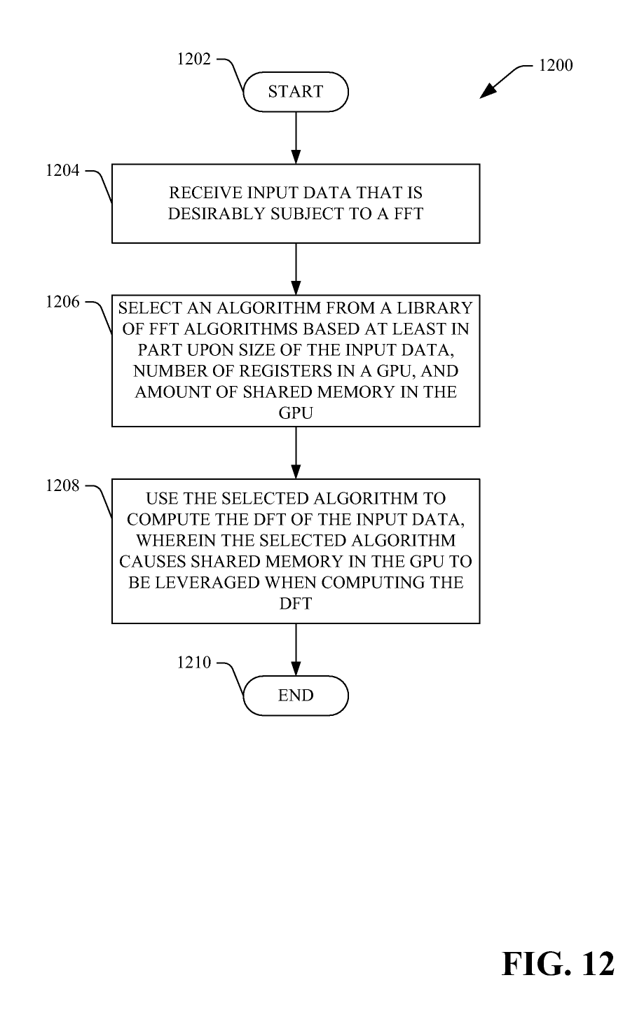

Referring now to FIG. 12, an example methodology 1200 for computing a DFT on a GPU is illustrated. The methodology 1200 starts at 1202, and at 1204 input data is received, wherein the input data is desirably subjected to a DFT. At 1206, an algorithm from a library of FFT algorithms is selected based at least in part upon size of the input data, number of registers in the graphics processing unit, and size of shared memory in the graphics processing unit. At 1208, the selected algorithm is used to compute the DFT of the input data, wherein the selected algorithm causes shared memory of the graphics processing unit to be leveraged when computing the DFT.

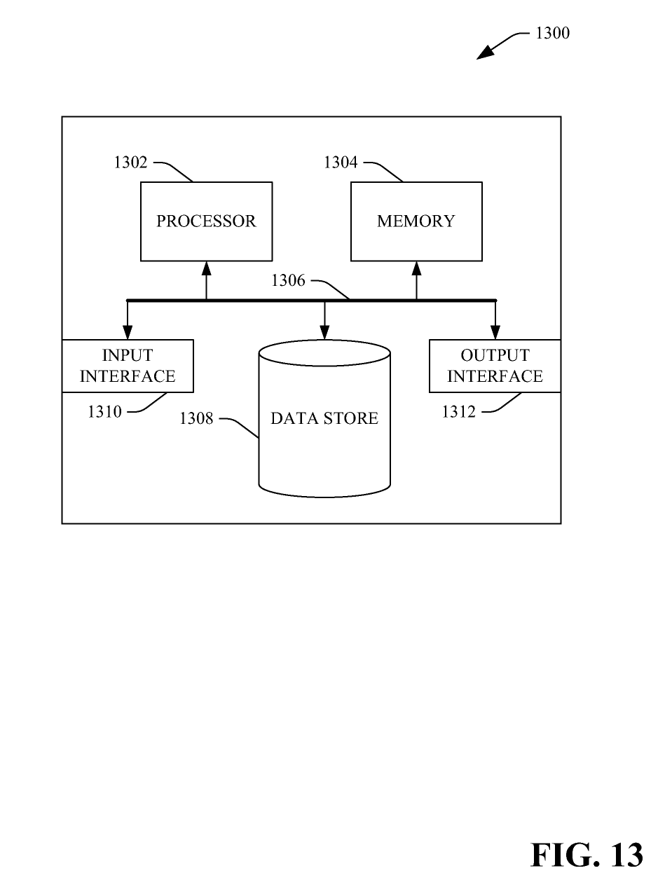

Now referring to FIG. 13, a high-level illustration of an example computing device 1300 that can be used in accordance with the systems and methodologies disclosed herein is illustrated. For instance, the computing device 1300 may be used in a system that supports computing DFTs. The computing device 1300 includes at least one processor 1302 that executes instructions that are stored in a memory 1304. The processor 1302 can be a CPU or a GPU, and the memory can be global memory or shared memory. The instructions may be, for instance, instructions for implementing functionality described as being carried out by one or more components discussed above or instructions for implementing one or more of the methods described above. The processor 1302 may access the memory 1304 by way of a system bus 1306. In addition to storing executable instructions, the memory 1304 may also store a plurality of algorithms for computing DFTs.

The computing device 1300 additionally includes a data store 1308 that is accessible by the processor 1302 by way of the system bus 1306. The data store 1308 may include executable instructions, algorithms for computing DFTs, etc. The computing device 1300 also includes an input interface 1310 that allows external devices to communicate with the computing device 1300. For instance, the input interface 1310 may be used to receive instructions from an external computer device, input data that is desirably subjected to a DFT, etc. The computing device 1300 also includes an output interface 1312 that interfaces the computing device 1300 with one or more external devices. For example, the computing device 1300 may display text, images, etc. by way of the output interface 1312.

Additionally, while illustrated as a single system, it is to be understood that the computing device 1300 may be a distributed system. Thus, for instance, several devices may be in communication by way of a network connection and may collectively perform tasks described as being performed by the computing device 1300.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A system comprising the following computer-executable components:
a selector component that receives input data that is desirably transformed by way of a Discrete Fourier Transform, wherein the selector component selects one of a plurality of algorithms for computing the Discrete Fourier Transform from a library based at least in part upon a size of the input data; and
an evaluator component that executes the selected one of the plurality of algorithms to compute the Discrete Fourier Transform, wherein the evaluator component leverages shared memory of a processor to compute the Discrete Fourier Transform.

2. The system of claim 1, wherein the selected one of the plurality of algorithms is global memory algorithm.

3. The system of claim 2, wherein the global memory algorithm causes data to be read in from global memory of the processor in contiguous segments and causes intermediate results for computing the Discrete Fourier Transform to be written to global memory in contiguous segments.

4. The system of claim 1, wherein the selected one of the plurality of algorithms is a shared memory algorithm.

5. The system of claim 4, wherein the shared memory algorithm causes the evaluator component to compute the Discrete Fourier Transform of the input data entirely in shared memory and registers of the processor.

6. The system of claim 1, wherein the selected one of the plurality of algorithms is a hierarchical algorithm, wherein the hierarchical algorithm combines at least one transpose operations with a Fast Fourier Transform computation on a Graphical Processing Unit.

7. The system of claim 1, wherein the processor is a graphics processing unit.

8. The system of claim 1, wherein the processor is a central processing unit.

9. The system of claim 1, wherein the processor comprises a multiprocessor, wherein the multiprocessor comprises the shared memory.

10. The system of claim 1, wherein the selector component selects the selected one of the plurality of algorithms based at least in part upon characteristics of the processor.

11. The system of claim 1, wherein the evaluator component is configured to execute a mixed-radix Discrete Fourier Transform algorithm.

12. The system of claim 1, wherein the input data is a non-power of two size and the evaluator component is configured to execute Bluestein's Fast Fourier Transform algorithm.

13. The system of claim 12, wherein the evaluator component is configured to employ modular arithmetic in Bluestein's Fast Fourier Transform algorithm to facilitate improving numerical accuracy of the computed Discrete Fourier Transform.

14. The system of claim 1, further comprising a conflict component that pads a number of empty values in the shared memory to facilitate reduction of bank conflicts in the shared memory.

15. A method comprising the following computer-executable acts:
receiving input data that is desirably subject to a Discrete Fourier Transform; and
computing the Discrete Fourier Transform of the input data, wherein the Discrete Fourier Transform is computed through use of shared memory in a graphics processing unit.

16. The method of claim 15, further comprising:
using the shared memory to exchange data between threads executing on the graphics processor, wherein the threads are configured to compute at least a portion of the Discrete Fourier Transform on the input data; and
writing intermediate results of the Discrete Fourier Transform to global memory of the graphics processor.

17. The method of claim 16, further comprising reading the intermediate results from the global memory for further processing by the threads, wherein the intermediate results are read from contiguous portions of the global memory.

18. The method of claim 15, further comprising computing the Discrete Fourier Transform without writing intermediate results to global memory of the graphics processing unit.

19. The method of claim 15, further comprising computing the Discrete Fourier Transform by way of a Bluestein FFT algorithm, a multi-dimensional FFT algorithm, and/or a real FFT algorithm

20. A computer-readable medium comprising instructions that, when executed by a graphics processing unit, perform the following acts:
receiving input data, wherein the input data is desirably subjected to a Discrete Fourier Transform;
selecting an algorithm from a library of Fast Fourier Transform algorithms based at least in part upon size of the input data, number of registers in the graphics processing unit, and size of shared memory in the graphics processing unit; and
using the selected algorithm to compute the Discrete Fourier Transform of the input data, wherein the selected algorithm causes shared memory of the graphics processing unit to be leveraged when computing the Discrete Fourier Transform.
